(19) United States
(12) Patent Application Publication
(10) Pub. No.: US 2003/0038117 A1
(43) Pub. Date: Feb. 27, 2003

(54) Method for producing boreholes, in particular injection orifices in nozzles, and device therefor

(76) Inventors: Josef Pickel, Heiligenstadt (DE); Heribert Duetsch, Memmelsdorf (DE); Juergen Schubert, Bamberg (DE); Stefan Kampmann, Isle of Palms, SC (US); Werner Hassel, Kasendorf (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/069,926

(22) PCT Filed: Jun. 20, 2001
(86) PCT No.: PCT/DE01/02277

(30) Foreign Application Priority Data
Jul. 1, 2000 (DE) 10032194.1

(51) Int. Cl. B23H 1/00; B23H 7/28; B23H 9/14

(52) U.S. Cl. 219/69.2; 219/69.17

(57) ABSTRACT

A method for producing bores in workpieces of electrically conductive material, in particular injection ports (11) in injection nozzles (10) is disclosed, in which method, by means of an erosion wire (12) forming an electrode, material in the workpiece forming the counterelectrode is removed in a targeted way by spark erosion. To produce bores of different cross-sectional shapes and/or a varying cross-sectional area over the length of the hole, the erosion wire (12) is actively excited to a defined vibration, and the form of vibration is established by targeted variation of the vibration excitation in accordance with the desired bore hole shape. A preferred apparatus for performing the method has a fastening unit (13), which receives the end (122) of the erosion wire (12) and which is driven by two actuators (14, 15) to execute a separate oscillating displacement along an x axis and a y axis (FIG. 1).

### PRIOR ART

The invention is based on a method for producing bores in workpieces of electrically conductive material, in particular injection ports in injection nozzles of fuel injection systems for motor vehicles, as generically defined by the preamble to claim 1.

In one known method of the type defined above, for producing bores by means of spark erosion a thin electrode, also called an erosion wire, is placed against the workpiece. In spark erosion, by chronologically separate electrical discharges between the erosion wire and the workpiece, material of the workpiece is increasingly removed, in the course of which the erosion wire also wears down. The discharges are effected via energy storing means with voltages of more than 20 V; the voltage, current, discharge frequency and pulse length are adapted to the drilling task (Dubbel, Taschenbuch für den Maschinenbau [Mechanical Engineering Handbook], volume 2, 13th Edition, page 669). For drilling conical bores, the electrode is tapered conically toward its free end, so that a conicity of the bore hole with a diameter that decreases in the direction of the machining feed is attainable.

### ADVANTAGES OF THE INVENTION

The method of the invention has the advantage that by the choice of the form of vibration of the erosion wire, bore holes of various cross-sectional shape can be produced, such as round, elliptical, square, and rectangular, as well as with a cross section that varies over the length of the hole, for instance being conical or barrel-shaped. For instance, a conicity of the bore hole with a tapering diameter can also be attained counter to the feed direction of the erosion wire; that is, the circular, elliptical or other cross section of the bore hole increases constantly in the drilling direction. The method of the invention is therefore especially well suited to producing injection ports in injection nozzles of fuel injection systems, where drilling of the injection ports at the injection nozzle is possible only from the outside inward, yet the conicity of the injection port has to extend in the converse direction, namely from a wide injection port diameter in the interior of the injection nozzle to a narrow injection port diameter on the outside of the injection nozzle.

By the provisions recited in the other claims, advantageous refinements and improvements to the method defined by claim 1 are possible.

In an advantageous embodiment of the invention, the vibration excitation is performed on one end of the wire, and the vibration excitation of the erosion wire is performed separately in two orthogonal axes located in the same plane. To attain the desired form of vibration of the erosion wire, the frequencies and the ratio of frequency to amplitude of the two vibration excitations as well as the phase displacement between the two vibration excitations in both orthogonal axes are controlled. By the choice of the frequency ratio, amplitude ratio and phase displacement between the vibration excitations, any shape of the bore hole cross section can be achieved in accordance with the known Lissajous' figures, such as round, elliptical, square, and rectangular. By varying the frequencies of the vibration excitations, the erosion wire can be set into natural resonance with different vibration modes. For instance, at the first harmonic of the resonant frequency at the erosion wire, a vibration mode with only one vibration node, located at the fastening end of the erosion wire, occurs. In its vibration, the erosion wire describes a conical jacket face, whose outline on the free end of the wire can for instance be a circle or an ellipse, depending on the choice of the amplitude ratio and of the phase displacement. The eroded bore hole is given a conicity that increases steadily at the inside cross section throughout the depth of the hole. With a vibration excitation whose frequency is equivalent to the second harmonic of the resonant frequency of the erosion wire, a vibration mode with two vibration nodes is achieved. If the frequency and the wire length are adapted to one another in such a way that the second vibration node is located close to the free end of the erosion wire, then the form of vibration of the erosion wire has a curved course extending over the length of the wire, and the eroded bore hole has a barrel-shaped inside contour over its length.

An advantageous apparatus for performing the method of the invention is defined by claim 4. Advantageous embodiments of the apparatus are recited in claims 5-7.

### DRAWING

The invention is described below in further detail in terms of an exemplary embodiment shown in the drawing. Shown are:

FIG. 1, a schematic perspective view of an apparatus for producing an injection port in an injection nozzle for a fuel injection system in motor vehicles;

FIGS. 2 and 3, each, an erosion wire of the apparatus of FIG. 1, in two different vibration modes;

FIGS. 4 and 5, each, one cross-sectional shape of an eroded injection port.

### DESCRIPTION OF THE EXEMPLARY EMBODIMENT

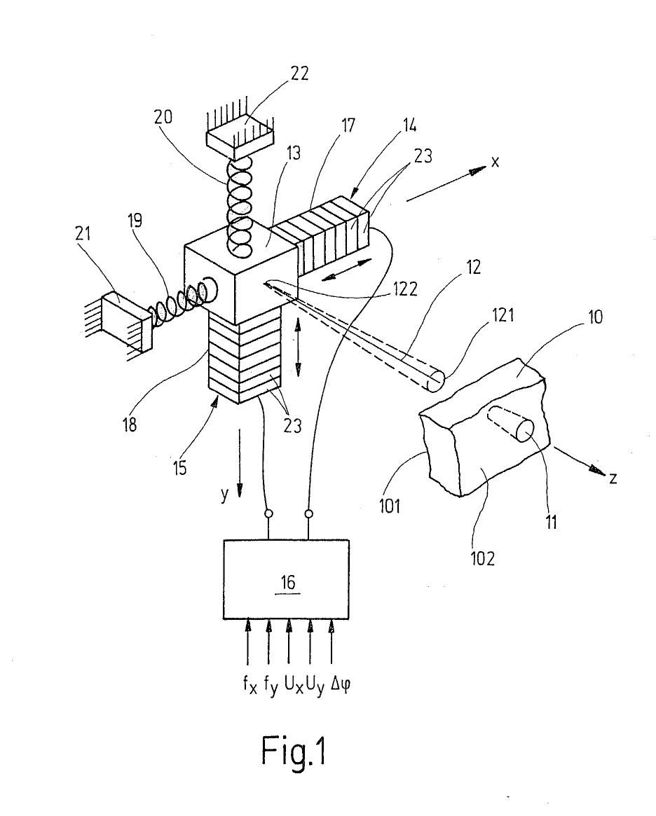

In the method, which can be performed by means of the apparatus sketched in FIG. 1, for producing an injection port 11 in an injection nozzle 10, shown only in part, of a fuel injection system for motor vehicles, a thin erosion wire 12 is introduced from outside by its tip 121 as far as the injection nozzle 10, which comprises electrically conductive material, and by spark erosion between the two electrodes formed by the erosion wire 12 and the injection nozzle 10, material is purposefully removed from the wall of the injection nozzle 10 in order to produce the injection port 11. The removal is brought about by successive, chronologically separate, non-steady-state electrical discharges, and the discharges are effected from energy storing means with voltages of more than 20 V. The voltage, current, discharge frequency and pulse length are adjusted accordingly to achieve an optimal drilling outcome.

To achieve different bore hole shapes, whose bore hole cross section also varies over the length of the injection port 11, for instance widening conically—as shown in FIG. 1—from the outer wall 101 of the injection nozzle 10 to the inner wall 102 of the injection nozzle 10, the erosion wire 12, on its end 122 remote from the machining tip 121, is excited to a defined vibration; by purposeful variation of the vibration excitation, the form of vibration is adjusted to suit the desired bore hole shape. The vibration excitation of the wire end 122 is performed in two orthogonal axes x, y located in the same plane. The erosion wire 12 is perpendicular to the plane defined by the x and y axes and extends in the z direction of an orthogonal, triaxial coordinate system.

To attain the desired form of vibration of the erosion wire 12, the frequencies of the vibration excitations in the x and y axes, the frequency ratio and the amplitude ratio of the two vibration excitations, and the phase displacement between the vibration excitations in both orthogonal axes x, y are controlled. For instance, to attain a bore hole of circular cross section, as is shown in FIG. 4, the vibration excitations in the two orthogonal axes x, y are performed with the same amplitude and with a phase displacement of 90°. To produce an injection port 11 of elliptical cross-sectional area (FIG. 5), the vibration excitations in both axes x, y are performed with a different amplitude but again with a phase displacement of 90°. In accordance with the known Lissajous' figures, square or rectangular cross-sectional areas of the bore hole can also be eroded. In this case, the frequency ratio of the vibration excitations in the x and y axes should be set as other than 1; the square cross-sectional shape can be achieved by setting equal amplitudes, while the rectangular shape can be achieved by setting different amplitudes.

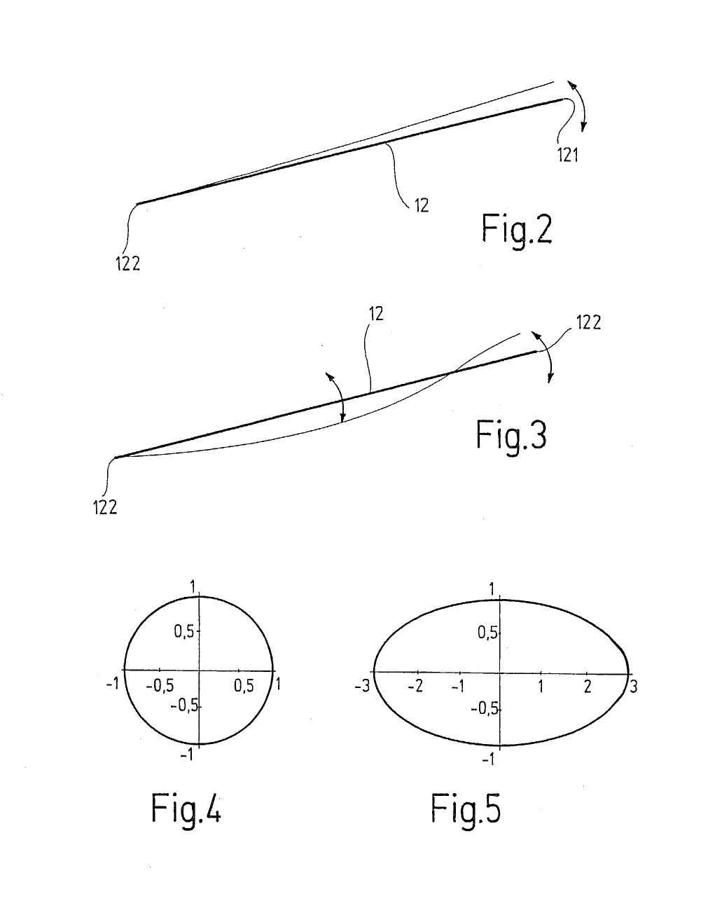

By a suitable choice of the excitation frequencies, which correspond to the natural resonance of the erosion wire 12 or to higher harmonics of the natural resonance, the erosion wire 12 can be excited to vibrate in different vibration modes, as is shown in FIGS. 2 and 3. In FIG. 2, the erosion wire 12 is set into natural resonance at the fundamental frequency. It vibrates in a vibration mode with one vibration node, which is located at the fastening end 122 of the erosion wire 12. The erosion wire 12 virtually describes a conical jacket face, whose outline circle is a circle or an ellipse, depending on the setting of the amplitudes of the vibration excitations in the x and y axes. In this vibration mode, the erosion wire 12 erodes a conically widening injection port 11, as is shown in FIG. 1 in the wall of the injection nozzle 10.

In the view shown in FIG. 3, the erosion wire 12 is excited with the second harmonic of its resonant frequency. The erosion wire 12 vibrates in a second vibration mode with two vibration nodes, one vibration node again being located on the fastening end 122 of the erosion wire 12, while the other vibration node develops at or near the free end, that is, the machining tip 121, of the erosion wire 12. If an injection port 11 is eroded with the erosion wire 12 vibrating at this kind of vibration mode, then the bore hole cross section of this injection port varies over the length of the bore approximately in the shape of a barrel, that is, with its greater bore diameter in the middle of the bore and with a smaller bore diameter at the beginning and end of the injection port 11.

For performing the method described, an apparatus is used of the kind shown schematically in perspective in FIG. 1. This apparatus has a fastening unit 13, in which the wire end 122 of the erosion wire 12 is fastened. The fastening unit 13 is guided displaceably in two orthogonal axes x, y oriented transversely to the longitudinal axis of the erosion wire 12. The displacement motions of the fastening unit 13 in the x axis and the y axis are generated by a respective actuator 14 and 15 that engages the fastening unit 13. The two actuators 14, 15 are controlled by a control unit 16, into which the parameters of frequencies f, amplitudes U and phase displacement Δφ of the desired vibration excitation of the erosion wire 12 are input, and which in accordance with the values of the input parameters controls the actuators 14, 15.

In the exemplary embodiment of FIG. 1, the actuators 14, 15 are embodied as so-called piezoelectric stacks 17, 18. In each piezoelectric stack 17 and 18, a plurality of piezoelectric elements 23 is disposed, contacting one another, in the direction of their change in length. On the counterpart face of the fastening unit 13, which is remote from the engagement face of the respective piezoelectric stack 17, 18, one end of a compression spring 19 and 20, respectively, is braced, whose other end rests on a stationary abutment 21 and 22, respectively. When an alternating voltage of amplitude U is applied to the piezoelectric stack 17 or 18, the piezoelectric stack 17 or 18 undergoes a change in length in the direction of the x or y axis, so that the fastening unit 13 is excited to execute an oscillating motion, on the one hand in the direction of the x axis and on the other in the direction of the y axis. The vibration stroke is dependent on the amplitude U of the alternating voltage, and the vibration frequency is dependent on the frequency f of the alternating voltage. The compression springs 19, 20 assure a reliable, non-positive contact of the piezoelectric stacks 17, 18 with the fastening unit 13.

If only slight vibration amplitudes of the fastening unit 13 in the x and y directions are necessary, then a single piezoelectric element 23 suffices as the actuator 14 or 15. Alternatively, the actuators 14, 15 can also be embodied by means of electromechanical vibration motors or ultrasonic transmitters.

1. A method for producing bores in workpieces of electrically conductive material, in particular injection ports (11) in injection nozzles (10) of fuel injection systems for motor vehicles, in which method, by means of an erosion wire (12) forming an electrode, material in the workpiece forming the counterelectrode is removed in a targeted way by spark erosion, characterized in that the erosion wire (12) is actively excited to a defined vibration, and that the form of vibration is established by targeted variation of the vibration excitation in accordance with the desired bore hole shape.

2. The method of claim 1, characterized in that the vibration excitation of the erosion wire (12) is performed on one end (122) of the wire.

3. The method of claim 2, characterized in that the vibration excitation of the erosion wire (12) is performed separately in two orthogonal axes (x, y) located in the same plane, and that to attain the desired form of vibration of the erosion wire (12), the frequencies and the ratio of frequency to amplitude of the two vibration excitations as well as the phase displacement between the two vibration excitations in both orthogonal axes are controlled.

4. The method of claim 3, characterized in that to attain a bore hole of circular cross section, the vibration excitations in the two orthogonal axes (x, y) are performed with the same amplitude and with a phase displacement (Δφ) of 90°.

5. The method of claim 3, characterized in that to create a bore hole of elliptical cross-sectional area, the vibration excitations in the two orthogonal axes (x, y) are performed with different amplitudes and with a phase displacement (Δφ) of 90°.

6. An apparatus for performing the method of one of claims 35, characterized in that the end (122) of the erosion wire (12) is received in a fastening unit (13), which is guided displaceably along two orthogonal axes (x, y) oriented transversely to the longitudinal axis of the erosion wire (12), and that two actuators (14, 15) engage the fastening unit (13) for separate oscillating displacement of the fastening unit (13) along the two orthogonal axes (x, y).

7. The apparatus of claim 6, characterized in that the actuators (14, 15) have piezoelectric elements (23), which upon application of an alternating voltage undergo a defined change in length in one direction and the other.

8. The apparatus of claim 7, characterized in that the actuators (14, 15) are each formed by a piezoelectric stack (17, 18), in which a plurality of piezoelectric elements (23) are disposed in contact with one another in the direction of their change in length.

9. The apparatus of claim 6, characterized in that the actuators (14, 15) are embodied as electromechanical vibration motors.

10. The apparatus of claim 6, characterized in that the actuators (14, 15) are embodied as ultrasonic transmitters.
